(19) United States
(12) Patent Application Publication
(10) Pub. No.: US 2025/0384461 A1
(43) Pub. Date: Dec. 18, 2025

(54) METHOD AND APPARATUS FOR RETURN EVALUATION, DEVICE AND STORAGE MEDIUM

(71) Applicant: Lemon Inc., Grand Cayman (KY)

(72) Inventors: Haocheng ZHANG, Los Angeles, CA (US); Hongyu XIONG, Los Angeles, CA (US); Yasong LI, Beijing (CN); Tian QIN, Los Angeles, CA (US); Bin LIU, Los Angeles, CA (US)

(21) Appl. No.: 18/878,833

(22) PCT Filed: Jun. 22, 2023
(86) PCT No.: PCT/SG2023/050441

§ 371 Date: Dec. 24, 2024

(30) Foreign Application Priority Data
Jun. 27, 2022 (CN) 202210743880.6

(51) Int. Cl. G06Q 30/0242; G06Q 30/0241

(52) U.S. Cl. CPC G06Q 30/0242; G06Q 30/0249; G06Q 30/0277

(57) ABSTRACT

According to embodiments of the disclosure, a method and apparatus for return evaluation, a device and a storage medium are provided. The method includes: obtaining at least one return rate metric of a content delivery plan at at least one time point; obtaining at least one return adjustment coefficient for the at least one time point of the content delivery plan; adjusting the at least one return rate metric respectively with the at least one return adjustment coefficient, to obtain at least one adjusted return rate metric; and determining a target return rate metric for the content delivery plan based on the at least one adjusted return rate metric, the target return rate metric indicating a return rate metric that can be reached upon expiration of a revenue returning period after consuming a cost at the at least one time point.

This application claims priority to Chinese invention patent application No. 202210743880.6, filed on Jun. 27, 2022 and entitled “METHOD AND APPARATUS FOR RETURN EVALUATION, DEVICE, AND STORAGE MEDIUM”.

### FIELD

Example embodiments of the present disclosure generally relate to the field of computer technology, and in particular, to a method, an apparatus, a device and computer-readable storage medium for return evaluation.

### BACKGROUND

The Internet provides access to a wide variety of content. For example, various types of images, audio, video, web pages, and the like may be accessed through the Internet. In addition, accessible content also includes specific content items related to various types of objects, including advertisements, for example. A content provider having resources may provide delivery about content items to a content delivery party. Successful conversion of the content items, such as download, registration, purchase, or other information demand actions, may bring certain revenue to the content delivery party. Content items are typically provided by the advertisement delivery party after negotiating with the content provider, and the advertisement delivery party may also pay the content provider based on the access to the advertisement. Therefore, there is a need to measure return-related metrics associated with content items.

### SUMMARY

In a first aspect of the present disclosure, a method for return evaluation is provided. The method includes: obtaining at least one return rate metric of a content delivery plan at at least one time point, the return rate metric being determined based on a cost consumed at a corresponding time point and revenue returned at the corresponding time point; obtaining at least one return adjustment coefficient for the at least one time point of the content delivery plan; adjusting the at least one return rate metric respectively with the at least one return adjustment coefficient, to obtain at least one adjusted return rate metric; and determining a target return rate metric for the content delivery plan based on the at least one adjusted return rate metric, the target return rate metric indicating a return rate metric that can be reached upon expiration of a revenue returning period after consuming a cost at the at least one time point.

In a second aspect of the present disclosure, an apparatus for return evaluation is provided. The apparatus includes: a metric obtaining module configured to obtain at least one return rate metric of a content delivery plan at at least one time point, the return rate metric being determined based on a cost consumed at a corresponding time point and revenue returned at the corresponding time point; an adjustment coefficient obtaining module configured to obtain at least one return adjustment coefficient for the at least one time point of the content delivery plan; a metric adjustment module configured to adjust the at least one return rate metric respectively with the at least one return adjustment coefficient, to obtain at least one adjusted return rate metric; and a target metric determination module configured to determine a target return rate metric for the content delivery plan based on the at least one adjusted return rate metric, the target return rate metric indicating a return rate metric that can be reached upon expiration of a revenue returning period after consuming a cost at the at least one time point.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method according to the first aspect.

In a fourth aspect of the present disclosure, a computer-readable storage medium is provided. The medium has a computer program stored thereon, and the computer program, when executed by the processor, implements the method according to the first aspect.

It should be appreciated that the content described in this section is not intended to limit critical features or essential features of the embodiments of the disclosure, nor is it intended to limit the scope of the disclosure. Other features of the present disclosure will become readily appreciated from the following description.

### BRIEF DESCRIPTION OF DRAWINGS

The above and other features, advantages and aspects of embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIG. 2 illustrates a flowchart of a process of return evaluation according to some embodiments of the present disclosure;

FIG. 3A illustrates an example of a timeline of revenue after attribution and cost of a content delivery plan according to some embodiments of the present disclosure;

FIG. 3B illustrates an example of an acquisition timeline of revenue and cost of a content delivery plan according to some embodiments of the present disclosure;

FIG. 4 illustrates an example graph of a return rate metric ratio according to some embodiments of the present disclosure;

FIG. 5 illustrates a flowchart of a process of determining a return adjustment coefficient according to some embodiments of the present disclosure;

FIG. 6 illustrates a block diagram of an apparatus for return evaluation according to some embodiments of the present disclosure; and

FIG. 7 illustrates an electronic device in which one or more embodiments of the present disclosure may be implemented.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may also be included below.

It will be appreciated that the data involved in the technical solution (including but not limited to the data itself, the obtaining or use of the data) should comply with the requirements of the corresponding legal regulations and related provisions.

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations.

For example, in response to receiving an active request from a user, prompt information is sent to the user to explicitly prompt the user that an operation requested by the user will require obtaining and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It can be understood that the above notification and user authorization process are only illustrative which do not limit the implementation of this disclosure. Other methods that meet relevant laws and regulations can also be applied to the implementation of this disclosure.

As used herein, the term “model” may learn association between corresponding inputs and outputs from training data, so that after the training is complete, a corresponding output may be generated for a given input. The generation of the model may be based on a machine learning technology. Depth learning is a machine learning algorithm that processes inputs and provides corresponding outputs by using a multi-tiered processing unit. A neural network model is one example of a model based on deep learning. Herein, “model” may also be referred to as “machine learning model,” “learning model,” “machine learning network,” or “learning network”, which may be used interchangeably herein.

A “neural network” is a machine learning network based on depth learning. A neural network is capable of processing inputs and providing corresponding outputs, which typically include an input layer and an output layer and one or more hidden layers between the input layer and the output layer. Generally, a neural network used in a deep learning application includes a lot of hidden layers, thereby increasing the depth of the network. The various layers of the neural network are connected in sequence such that the output of a previous layer is provided as the input of a subsequent layer, wherein the input layer receives the input of the neural network and the output of the output layer is provided as the final output of the neural network. Each layer of the neural network includes one or more nodes (also referred to as processing nodes or neurons), and each node processes the input from a previous layer.

Generally, machine learning may roughly include three phases, namely a training phase, a testing phase, and an application phase (also referred to as an inference phase). In the training phase, a given model may be trained by using a large amount of training data, constantly and iteratively updating parameter values until the model obtains consistent reasoning that meets expected goals from the training data. By training, the model may be considered as being able to learn an association between input and output from training data (also referred to as mappings of input to output). A parameter value of the trained model is determined. In the testing stage, a test input is applied to the trained model, so as to test whether the model can provide a correct output, thereby determining the performance of the model. In the application phase, the model may be configured to process actual input based on the trained parameter value to determine corresponding output.

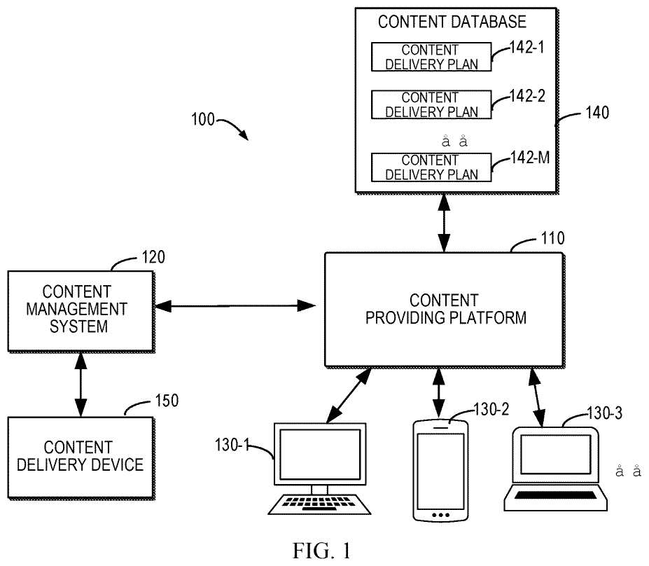

FIG. 1 illustrates a schematic diagram of an example environment 100 in which embodiments of the present disclosure can be implemented. One or more content providers may use content management system 120 to manage content to be provided on a content providing platform 110. Herein, “content provider” refers to a party that maintains the content providing platform and is capable of serving content for a terminal device.

One or more terminal devices 130-1, 130-2, 130-3, etc. (collectively or individually referred to as the terminal devices 130 for ease of discussion) are associated with the content providing platform and may access various types of content provided on the content providing platform 110. As an example, the content providing platform 110 may be applications, websites, web pages, and other accessible resources. The terminal device 130 may be installed with an application, may access a website or a webpage, or may access corresponding resources in a suitable manner.

The content provider may provide different content to different terminal devices 130 based on content management requirements and based on user operations at the terminal devices 130. The content management system 120 may provide one or more specific content items related to one or more objects to the terminal device 130. Such content items include, for example, advertisements. Such content items include, for example, advertisements, and objects related to the content items include, for example, objects targeted by the advertisements. In some embodiments, a content delivery party may be allowed to configure content delivery plans 142 via a content delivery device 150, such as one or more content delivery plans 142-1, 142-2, . . . 142-M in content database 140 (collectively or individually referred to as content delivery plans 142 for ease of discussion). The content delivery plan may include, for example, an advertisement delivery plan. The content delivery plan 142 may indicate one or more aspects of a specific content item to be delivered, a supply policy of the content item, a budget of the content item, an expected return, and the like.

In some embodiments, the content management system 120 may provide the content item to the one or more terminal devices 130 according to the content delivery plan 142 based at least on a request from the content delivery party, such as, based on a bid request of the content delivery party. For example, the content delivery party may request delivery of the content item from the content management system 120 via the content delivery device 150. As used herein, a “content delivery party” refers to a party requesting delivery of a content item on a content providing platform. In an advertisement delivery scenario, a “content delivery party” is sometimes referred to as an “advertiser”.

In the environment 100, the terminal device 130, the content management system 120, and/or the content delivery device 150 may be various types of devices capable of providing computing capabilities, including a mainframe, an edge computing node, a computing device in a cloud environment, a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination thereof, including accessories and peripherals of these devices or any combination thereof.

It should be understood that the structure and function of various elements in the environment 100 are described for illustrative purposes only, which do not imply any limitation on the scope of the present disclosure.

In a scenario of content item provision, it is usually necessary to measure various metric indices related to a content delivery plan, including metric indices related to a return rate. For a content delivery party, execution of a content delivery plan needs to consume a certain cost, so it is desirable to obtain a satisfactory return rate metric. In some cases, during execution of a content delivery plan, it is desirable to be able to measure a return rate metric of the content delivery plan in real time for guiding execution of subsequent plans to meet requirements of content delivery.

One example of the return rate metric includes a ratio of the revenue to the cost of the content delivery play. After the content item is provided, the conversion of the content item may bring a certain revenue to the content delivery party, where the “conversion” indicates download, registration, purchase, or other information demand behavior that occurs due to the influence of the provided content item. In an advertisement delivery scenario, the return rate metric includes Return on Advertising Send (ROAS). According to the definition, ROAS may be determined as a ratio of advertising revenue to advertising expenditure.

The conversion of the content delivery plan usually occurs outside the content providing platform, for example, in a platform managed by the content delivery party or a third-party platform. For example, download of a multimedia file may occur in a multimedia file source website; download of some applications may occur in an application download platform of a third party, for example, an application store of a terminal device or an application download website; and registration of an application may occur in an application platform, etc. In this case, a platform managed by the content delivery party or a third-party platform needs to feed back conversion data of the content delivery plan to the content provider, for example, revenue brought by conversion. The platform managed by the content delivery party or the third-party platform feeds back conversion data of the content delivery plan, also referred to as “conversion returning” or “revenue returning”.

In some scenarios, conversion return may be delayed due to privacy protection considerations or due to the property of content conversion. For example, certain conversion behaviors (e.g., payment) occur after a time period since the content delivery plan was delivered. For another example, in order to avoid tracking individual user behaviors, the conversion will not be fed back in real time. Such delayed conversion returning makes the cost to the content delivery plan inaccurate.

For example, on the third day after the content delivery plan is executed, the content provider may obtain part of the revenue. The content provider may typically obtain a real-time cost for the content delivery plan. Based on a part of revenue and the real-time cost obtained on the third day, the determined return rate metric will be lower than the actual cost, as revenue brought based on the content delivery plan may still be generated after the third day, or may be notified to the content provider after the third day.

An evaluation error of the return rate may cause many adverse effects, including adverse effects on real-time effect evaluation for the content delivery plan, subsequent execution of the content delivery plan, and the like.

In example embodiments of the present disclosure, an improved return evaluation solution is provided. According to the solution, at least one return adjustment coefficient for at least one time point of the content delivery plan is determined. Costs of the content delivery plan available at these time points are adjusted by the return adjustment coefficient, and a target return rate metric for the content delivery plan is determined based on the adjusted return adjustment coefficient such that the target return rate metric indicates a return rate metric that can be reached upon expiration of the revenue returning period after consuming cost at least one time point.

According to the solution, the obtained return rate metric is adjusted through a predetermined return adjustment coefficient, so that the obtained return rate metric can be close to the return rate metric measured at the target time point, and thus the accuracy of return evaluation is improved. Accurate return estimation can help adjust the content item supply strategy instantly and realize reasonable resource configuration when subsequent content delivery is executed, thereby avoiding waste in costs and resources.

Some example embodiments of the present disclosure will be described below with continued reference to the accompanying drawings.

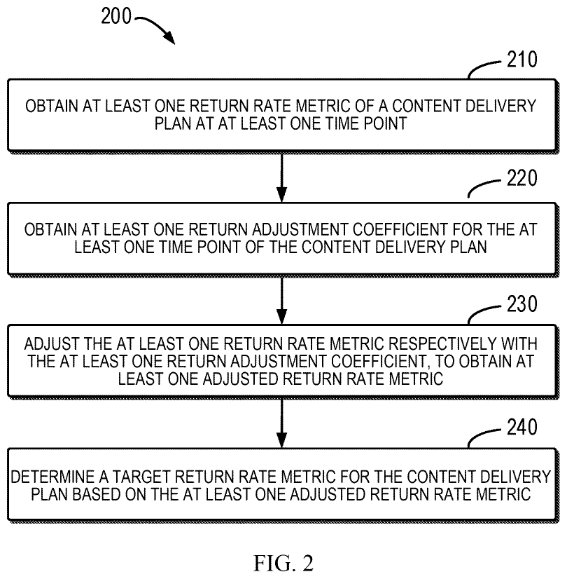

FIG. 2 illustrates a flowchart of a process 200 of return evaluation according to some embodiments of the present disclosure. Process 200 may be implemented, for example, at content management system 120.

At block 210, the content management system 120 obtains at least one return rate metric of a content delivery plan at at least one time point.

The content delivery plan refers to a behavior about content delivery to be performed by the content delivery party. The content delivery plan may need to consume some cost. In some embodiments, costs may be consumed (such as delivering content items) at a certain time interval since the content delivery plan is executed. In addition, a return rate metric of the content delivery plan may be measured at a certain time interval. The return rate metric at each time point may be determined based on the cost consumed at the corresponding time point and the revenue returned at the corresponding time point. The time interval between respective time points may be set according to actual application requirements, for example, may be set as hourly, daily, weekly, or the like. A return rate metric of a content delivery plan is a ratio of the obtained revenue to the cost, which is expected to be used to measure the content delivery plan, such as ROAS. In some examples below, ROAS is used as an example of a return rate metric for ease of discussion. The return rate of the content delivery plan may also be defined according to other criteria or rules.

The cost is typically obtained by the content management system 120, and the revenue may be determined after determining that a conversion occurred or may be provided to the content management system 120 by another platform. When measuring the return rate, due to the delay of revenue return, it may not be possible to measure all potential revenue of a certain content delivery at some time points. In addition, in some cases, a certain content delivery plan may continuously consume costs at a plurality of time points, and then the revenue returned at a certain time point may include both revenue attributed to the cost consumed at the time point and revenue obtained attributed to the cost consumed before the time point.

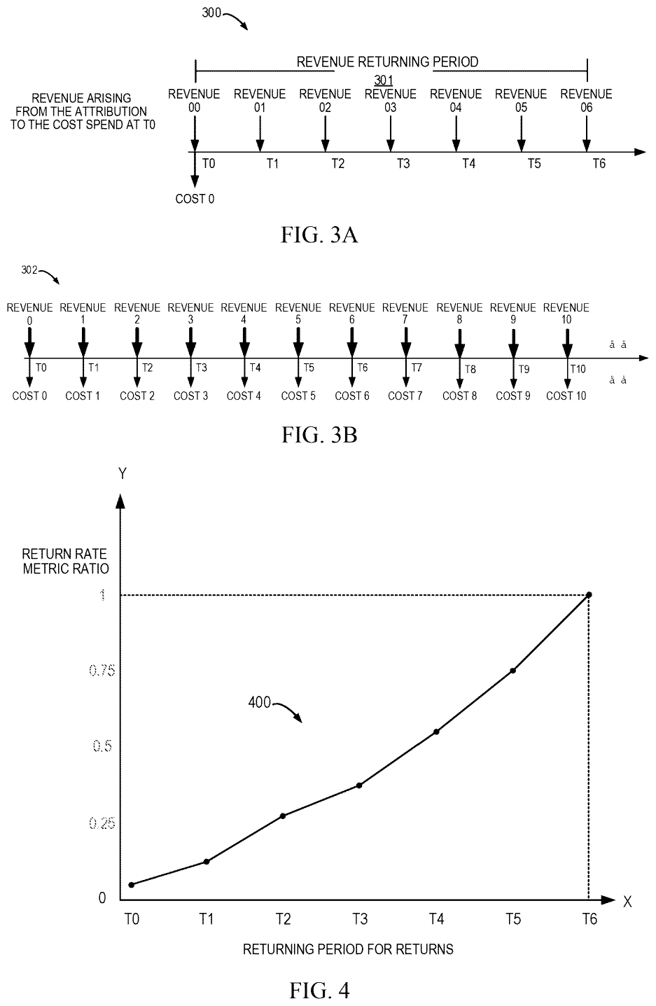

FIG. 3A illustrates an example of a timeline 300 of costs and revenue after attribution for a content delivery plan according to some embodiments of the present disclosure. In the example of FIG. 3A, T0 indicates a time point at which the content delivery plan starts delivery, for example, the current day the content delivery plan starts delivery, T1, T2, and the like refer to a time point after T0. It is assumed that at time point T0, the content delivery plan needs to consume “cost 0” and “revenue 00” is obtained for the delivery plan. Due to the delay of revenue return, “Cost 0” consumed at time point T0 may continue to bring revenue at subsequent time points, such as “Revenue 01” obtained at time point T1, “Revenue 02” obtained at time point T2, and so on. The revenue brought due to cost consumption (e.g., content item delivery) at a certain time point may be referred to as revenue attributed to this cost or this content delivery.

Generally, in the process of executing the content delivery plan, after the cost at a certain time point is consumed (that is, used for content delivery), there is a revenue returning period, and after the revenue returning period expires, the revenue attributed to this cost (or this delivery) is returned to the content management system. For example, in the example of FIG. 3A, the revenue returning period 301 lasts from the time point T0 to the time point T6. That is, at the time point T6, all pieces of revenue attributed to “Cost 0” have returned.

However, as described above, the content delivery plan may continuously deliver costs at multiple time points, and acquisition of such revenue and costs may be as shown in FIG. 3B. FIG. 3B illustrates an acquisition timeline 302 of revenue and costs of a content delivery plan. In FIG. 3B, at time point T0, the content delivery plan needs to consume “cost 0”, and the content management system 120 obtains “revenue 0” returned. At time T1, the content delivery plan needs to continue to consume “cost 1”, and the content management system 120 obtains “revenue 1” returned, and so on. The “revenue 1” may include revenue attributed to both “cost 0” and “cost 1”, and revenue obtained at another subsequent time point is similar.

In evaluating the return rate of a content delivery plan, it is desirable to be able to accurately determine the cost and all potential revenue that the cost can bring about. In view of the actual revenue returning situation, the return rate metric obtained at each time point may first be determined based on the cost consumed at that time point and the revenue returned at that time point.

For example, in the example of FIG. 3B, at time point T0, a return rate metric, such as roas₀, may be determined, and it may be calculated as a ratio of revenue 0 to cost 0. At time point T1, a return rate metric, such as roas₁, may be determined, for example, it may be determined based on the currently obtained revenue 1 and cost 1, such as it may be determined as a ratio of revenue 1 to cost 1. Similarly, at time point T2, a corresponding return rate metric may also be determined.

In a conventional solution, to predict a target return rate metric of a content delivery plan, return rate metrics determined at a plurality of time points are usually averaged, for example, return rate metrics determined at a plurality of points (for example, 7 time points) within a revenue returning period are averaged.

However, it can be seen that the return rate metric determined at any time point may not accurately reflect the accurate return rate of the content delivery plan, and the return rate metric determined in this way is usually lower than the actual return rate metric because the cost consumed at each time point will still bring potential benefits at the subsequent time points.

In an embodiment of the present disclosure, in order to determine a more accurate return rate metric, at block 220, the content management system 120 obtains at least one return adjustment coefficient for the at least one time point of the content delivery plan.

According to analysis and research and a large number of experiments, the inventor finds that certain content delivery plans or content delivery parties of the content delivery plans have certain characteristics in revenue data return, and such characteristics are also reflected in the return rate metric. In particular, the revenue returning period may also remain the same for a content delivery plan or a certain content party. For example, on the seventh day after the content delivery plan consumes a cost at a certain time point, the content management system 120 may obtain all pieces of revenue due to execution of the content delivery plan, that is, the revenue returning period is 7 days.

In addition to the revenue returning period, for a specific content delivery plan or a specific content delivery party, the feedback behaviors for revenue at respective time points may also meet a certain rule, so that a return rate metric predictable at each time point meets a certain change tendency. Generally, for a content delivery plan to be evaluated, if the evaluated time point is closer to the start time point of the delivery and is further from the target time point (i.e., the time point when the revenue returning is completed), it means that the return rate metric determined at that time point may be inaccurate, e.g., the return rate metric is estimated to be lower than the actual return rate metric. As time goes by, the closer to the target time point, the more accurate the predicted return rate metric.

Therefore, in the embodiments of the present disclosure, such a change tendency may be relied upon to determine the available return adjustment coefficient. Specifically, in the revenue returning period starting from cost being consumed, return adjustment coefficients respectively corresponding to the corresponding revenue returning time lengths starting from the cost consumption are determined. In some embodiments, a return adjustment coefficient may indicate a ratio of a return rate metric reached over a corresponding revenue returning time length starting from cost being consumed to a return rate metric reached upon expiration of the revenue returning period.

For example, assuming that the revenue returning is completed on the seventh day (i.e., T6) after a certain cost is delivered, the return rate metrics may be determined for time points T0, T1, . . . , T6 (i.e., the revenue returning period is from T0 to T6) as roas₀, roas₁, . . . , roas₆. The return rate metric roasᵢ determined herein refers to the revenue that is reached over each return time length in the revenue returning period due to the cost consumed by T0 (e.g., the delivered advertisement). For example, in the example of FIG. 3A, roas₀ at time point T0=revenue 00/cost 0; roas₁ at time point T1=(revenue 00+revenue 01)/cost 0, i.e., a ratio of a sum of the revenue obtained after one-day return (i.e., revenue 00+revenue 01) to the consumed cost. By analogy, roas₆ at time point T6=(revenue 00+revenue 01 . . . +revenue 06)/cost 0, i.e., a ratio of a sum of all revenue obtained after expiration of the revenue returning period for cost 0 to the consumed cost.

Based on the return rate metric reached over the corresponding revenue returning time length starting from cost being consumed, a return adjustment coefficient Rᵢ (e.g., i=0, 1, . . . 6) corresponding to each return time length may be determined. For example, Rᵢ may be determined as a ratio of the return rate metric roasᵢ reached over a return time length corresponding to the i-th time point to the return rate metric roas₆ reached upon expiration of the revenue returning period (e.g., at time point T6). It can be seen that after cost consumption, the measured return rate metric is lower at a time point closer to the cost consumption, so the value of the determined return adjustment coefficient Rᵢ will also be lower. When the revenue returning period expires, the return adjustment coefficient Rᵢ is equal to 1.

FIG. 4 illustrates an example curve 400 of a return rate metric ratio according to some embodiments of the present disclosure. In FIG. 4, the X-axis indicates time in the revenue returning period, T0 represents the time points of a certain cost consumption; the Y-axis indicates the ratios of return rate metrics. Each point on curve 400 corresponding to T0 through T6 corresponds to Rᵢ, which indicates the ratio of a return rate metric roasᵢ reached over the revenue returning time length corresponding to that time point to the return rate metric roas₆ reached upon the expiration of the revenue returning period. Typically, such a ratio of return rate metrics may be similar for each revenue returning period, given the revenue returning pattern of a particular content delivery plan or particular content delivery party.

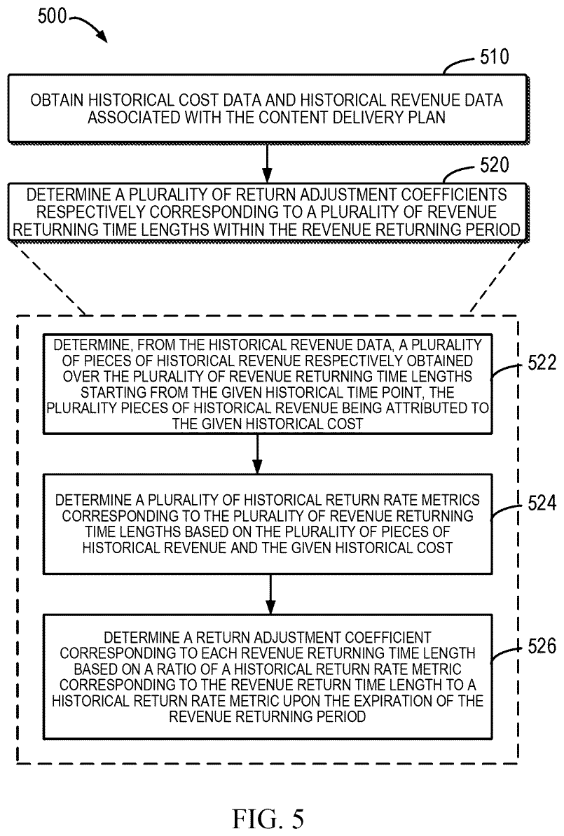

In some embodiments, return adjustment coefficients may be determined based on historical revenue data and historical cost data associated with the currently evaluated content delivery plan. The determination of the return adjustment coefficients will be discussed in detail below with reference to FIG. 5.

At block 230, the content management system 120 adjusts the at least one return rate metric respectively with the at least one return adjustment coefficient, to obtain at least one adjusted return rate metric. A return adjustment coefficient corresponding to each time point may be determined, and the return rate metric determined at each time point may be adjusted using the coefficient to a return rate metric that is closer to a return rate metric that can be reached after all of the revenue due to the cost consumed at that point are returned. At block 240, the content management system 120 determines a target return rate metric for the content delivery plan based on the at least one adjusted return rate metric. The target return rate metric indicates a return rate metric that can be reached upon expiration of the revenue returning period after cost consumption at the at least one time point.

In some embodiments, for a given time point among the at least one time point, a given revenue returning time length may be determined based on a time length between the given time point and a last time point among the at least one time point. In this way, at least one return adjustment coefficient corresponding to a given revenue returning time length may be selected from a plurality of return adjustment coefficients.

In some embodiments, in predicting a return rate, at least the return rate metric for the current time point may be obtained, and if exists, the return rate metric for one or more time points preceding the current time point may also be obtained. In some embodiments, if there are adequate return rate metrics before the current time point, a return rate metric over one revenue returning period prior to the current time point may be selected for adjusting and determining the target return rate metric.

For example, in the example of FIG. 3B, if the current time point is T8, a return rate metric corresponding to a time point from T2 to T8 may be selected, where T2 to T8 correspond to a revenue returning period. For another example, if the content delivery plan starts to be executed for a short time, for example, the execution starts from the time point T0, and the current time point is T3, a return rate metric corresponding to a time point from T0 to T3 may be selected.

For the return rate metric at the current time point, the revenue returning time length is 0, so a return adjustment coefficient R₀ may be selected, which indicates a ratio of a return rate metric for the revenue returning time length of 0 to a return rate metric reached upon expiration of the revenue returning period. Then, the return rate metric determined at the current time point is adjusted with the return adjustment coefficient R₀. For time points before the current time point, considering that the costs consumed at these time points have obtained revenue returning for a period of time, an appropriate return adjustment coefficient may be selected based on the revenue returning time length.

In some embodiments, if the return rate metrics at multiple time points are considered, the obtained multiple adjusted return rate metrics may be aggregated to determine the target return rate metric. For example, costs consumed respectively at multiple time points may be determined, and revenue to be obtained upon the expiration of a revenue returning period by the cost consumed at the respective time points is determined based on the adjusted return rate metrics and the corresponding costs at the respective time points. Then, the ratio of the sum of the revenue determined for the plurality of time points to the sum of the costs at the plurality of time points is determined as the target return rate metric. In one example, the target return rate metric roasₚ may be determined as follows:

$${roas}_{p} = \frac{{\sum }_{0 <= i <= min ( n , 6 )} {roas}_{n - i} * {cost}_{n - i} / {R}_{i}}{{\sum }_{0 <= j <= min ( n , 6 )} {cost}_{j}}$$

Where n represents a time point after the content delivery plan starts to be executed, roasₙ₋ᵢ indicates a return rate metric determined at the (n-i)-th time point, and costₙ₋ᵢ indicates cost at the (n-i)-th time point. In equation (1) above, roasₙ₋ᵢ/Rᵢ may correspond to the adjusted return rate metric. In equation (1), it is assumed that the revenue returning period includes 7 time points. However, the revenue reflow period may be set according to the content delivery plan or to the content delivery party, and may be set to any other value.

In an example, according to the above formula (1), if the target return rate metric is predicted at the time point T3 after the content delivery plan starts to be executed, that is, n=3, return rate metrics roas₀, roas₁, roas₂ and roas₃ at T0, T1, T2 and T3 may be obtained. The return adjustment coefficient R₀ may be used to adjust the return rate metric roas₃ at the current time point T3, so at T3, the revenue returning time length for the cost at this time point is 0. The return rate metric roas₂ at the current time point T2 may be adjusted with the return adjustment coefficient R₁, so at T3, the revenue returning time length for the cost at the time point T2 is 1, and so on. In another example, if the target return rate metric is predicted at time T8 after the content delivery plan starts to be executed, i.e., n=8, the return rate metrics roas₂, roas₃, . . . roas₈ at T2, T3, . . . . T8 may be obtained. The return adjustment coefficient R₀ may be used to adjust the return rate metric roas₈ at the current time point T8, so at T8, the revenue returning time length for the cost at the time point is 0. The return adjustment coefficient R₁ may be used to adjust the return rate metric roas₇ at the current time point T7, so the revenue returning time length of the cost at the time point T7 at T8 is 1. By analogy, the return rate metric roas₂ of the current time point T2 may be adjusted with the return adjustment coefficient R₆, because when at T8, the return time length for the cost at the time point T2 is 6, that is, all return is completed.

In some embodiments, in addition to the above formula (1), the target return rate metric roasₚ may be determined in other manners, for example, based on a machine learning model or a neural network model. In such embodiments, inputs to the model may include an adjusted return rate metric (or predicted return rate metrics at respective time points, and return adjustment coefficients), costs, and/or other characteristic information related to the content delivery plan. The model may automatically determine a more accurate target return rate metric roasₚ through training learning.

The determined target return rate metric roasₚ may indicate the return rate reached after considering the potential revenue that the content delivery plan will obtain from the corresponding time point (e.g., after the revenue returning is complete), i.e., the ratio of the potential revenue that the content delivery plan will obtain to the consumed cost. The target return rate metric roasₚ can accurately evaluate the return related index of the content delivery plan.

By adjusting the return rate metric actually obtained at each time point, the target return rate metric roasₚ is determined to take the potential returned revenue in the future into account. Such a target return rate metric can more accurately reflect the effect of content delivery, and can be applied to a plurality of evaluations and applications scenarios related to a content delivery plan for guiding delivery strategy formulation, resource allocation of content supply, and other aspects.

In some embodiments, the budget usage recommendation for the content delivery plan may be determined based on a target return rate metric roasₚ. The budget usage recommendation may be used to plan usage of budget resources for the content delivery plan, such as how many cost resources are used at each time point. In some embodiments, the determination of the budget usage recommendation may also be related to an expected return rate metric for the content delivery plan. Typically, a content delivery party may expect to set a budget for content delivery, as well as a minimum return rate metric expected to be obtained, i.e., an expected return rate metric. When performing content delivery, it is generally desirable that the obtained actual return rate metric is greater than or equal to the expected return rate metric of the content delivery party, and it is also desirable to consume the cost as much as possible within the budget range. Thus, the content management system 120 may determine a budget usage recommendation for the content delivery plan, e.g., indicating costs consumed in each time period (e.g., daily).

In some examples, the budget usage recommendation may be determined as follows:

$$expectedCost = min ( {( \frac{{roas}_{p}}{min Roas} )}^{λ} * avg cost , originBudget ) \qquad ( 2 )$$

wherein
expectedCost represents a budget usage recommendation for a content delivery plan at each time point (e.g., daily);
originBudget represents a budget of the content delivery plan;
avgCost represents an average cost of the content delivery plan over the time since the content delivery plan starts to be executed;
minRoas represents an expected return rate metric for the content delivery plan, such as a lower limit of the return rate metric;
roasₚ represents a target return rate metric;
λ represents a preset parameter value for adjusting the ratio of the target return rate metric to the expected return rate, which may be set according to actual application, or may be omitted.

According to the above equation (2), the cost to be consumed by the content delivery plan in each time period (e.g., each day) can be determined. In some embodiments, as time goes by, a new target return rate metric may be determined according to the revenue fed back in real time, thereby the budget usage recommendation for the content delivery plan is updated in real time.

As can be seen from the above equation (2), if the adjusted target return rate metric is not utilized, but the return rate metric estimated directly from the currently available cost and revenue is utilized, since the return rate metric would in some cases be calculated to be lower than the actual return rate, the budget usage recommendation would tend to be conservative. This will result in low budget usage, unreasonable budget resource allocation, and thus cannot meet the expectation of the content delivery party. According to some example embodiments of the present disclosure, by improving the accuracy in determining the target return rate metric, there is a beneficial guiding effect on the budget resource allocation of the content delivery plan.

In some embodiments, in order to prevent the target return rate metric roasₚ from possibly being over-estimated, a parameter value (denoted as k) may be set to correct the target return rate metric roasₚ. In some embodiments, in determining the budget usage recommendation, the target return rate metric used may also be required to be greater than or equal to a return rate metric that is not adjusted at the current time point. Thus, a higher return rate metric of the target return rate metric roasₚ and the unadjusted return rate metric may be selected for determining the budget usage recommendation, so that the recommended usage cost is as close to the budget as possible.

The unadjusted return rate metric may be determined, for example, based on a return rate metric obtained at the current time point, for example, it may be determined as an average of these return rate metrics. Alternatively, it may be determined based on an aggregation of the return rate metrics and costs for the current and previous time points, e.g., as follows:

$${roas}_{{p}^{′}} = \frac{{\sum }_{0 <= i <= min ( n , 6 )} {roas}_{n - i} * {cost}_{n - i}}{{\sum }_{0 <= j <= min ( n , 6 )} {cost}_{j}} \qquad ( 3 )$$

The definition for elements in equation (3) above is consistent with the definition of the corresponding elements in equation (1) above, and roasₚ′ represents the unadjusted return rate metric.

In some embodiments, the manner for determining the budget usage in the above equation (2) may be modified as follows:

$$expectedCost = min ( {( \frac{max ( {roas}_{p} * k , {roas}_{{p}^{′} )}}{min Roas} )}^{λ} * avg cost , originBudget ) \qquad ( 4 )$$

Some embodiments of determination of the target return rate metric based on the return adjustment coefficient and utilization of the target return rate metric are discussed above. How to determine the return adjustment coefficient will be discussed below. FIG. 5 illustrates a flowchart of a process 500 of determining a return adjustment coefficient according to some embodiments of the present disclosure. The process 500 may be implemented, for example, at content management system 120.

At block 510, the content management system 120 may obtain historical cost data and historical revenue data associated with the content delivery plan.

In some embodiments, the historical cost data and the historical revenue data may be cost data and revenue data obtained in historical delivery of the content delivery plan. Based on such data, the return adjustment coefficients determined subsequently may be specific to the content delivery plan or other content delivery plans having similar characteristics as the content delivery plan.

In some embodiments, the historical cost data and the historical revenue data may be one or more content delivery plans related to a content delivery party corresponding to the content delivery plan, for example, the historical cost data and the historical revenue data may include other content delivery plans of the content delivery party. In such embodiment, the same content delivery party is considered to have similar characteristics in terms of revenue returning for the content delivery plans, so the return adjustment coefficients determined subsequently may be applicable to multiple content delivery plans of the content delivery party.

The historical cost data and historical revenue data may be obtained, for example, from a database for a particular content delivery plan or an active value optimization (VO) and application event optimization (AEO) plan of a particular content delivery party over a past period of time. The historical cost data may include historical costs of each content delivery plan at a plurality of time points after delivery, and the historical revenue data may include historical revenue of each content delivery plan at a plurality of time points after delivery.

At block 520, the content management system 120 determines, based on the historical cost data and the historical revenue data, a plurality of return adjustment coefficients respectively corresponding to a plurality of revenue returning time lengths within the revenue returning period. Assuming that the revenue returning is completed on the seventh day after the delivery of the content delivery plan, the corresponding return adjustment coefficients R₀, R₁, . . . . R₆ can be determined.

Specifically, when determining the return adjustment coefficient, for a given historical cost consumed at a given historical time point in the historical cost data, operations at blocks 522-526 may be operated. At block 522, a plurality of pieces of historical revenue respectively obtained over the plurality of revenue returning time lengths starting from the given historical time point are determined from the historical revenue data, the plurality pieces of historical revenue being attributed to the given historical cost.

For example, assuming that the revenue returning is completed on the seventh day after the delivery of the content delivery plan, the cost of each delivery (per day) is determined from the historical cost data, and a plurality of pieces of the historical revenue attributed to the cost are determined through revenue attribution, that is, the revenue returned respectively over the seven days from the delivery.

At block 524, a plurality of historical return rate metrics corresponding to the plurality of revenue returning time lengths are determined based on the plurality of pieces of historical revenue and the given historical cost. For example, for a certain cost delivered on a certain day, corresponding historical return rate metrics roas₀, roas₁, . . . roas₆ are determined. Each historical return rate metric may be determined as a ratio of historical revenue to cost. For each cost, a set of historical return rate metrics roas₀, roas₁, . . . roas₆ can be determined.

At block 526, a return adjustment coefficient corresponding to each revenue returning time length is determined based on a ratio of a historical return rate metric corresponding to the revenue returning time length to a historical return rate metric upon the expiration of the revenue returning period.

For example, for the set of historical return rate metrics roas₀, roas₁, . . . roas₆, a ratio of roasᵢ at any time point to roas₆ at a target time point may be determined, thereby obtaining the return adjustment coefficients R₀, R₁, . . . R₆.

In some embodiments, depending on the available historical data, a plurality of sets of historical return rate metrics roas₀, roas₁, . . . roas₆ may be determined, and for each set of historical return rate metrics, candidate return adjustment coefficients R₀, R₁, . . . . R₆ may be determined. Then, a final return adjustment coefficient is determined from candidate return adjustment coefficients at a corresponding time point in the plurality of sets of historical return rate metrics. For example, for a plurality of R₀ at the time point T0, a median value of the plurality of R₀ may be selected as the final return adjustment coefficient, or the plurality of R₀ may be averaged to calculate the final return adjustment coefficient. For candidate return adjustment coefficients at other time points, the final return adjustment coefficients may also be determined in a similar manner. By aggregating the return adjustment coefficients determined from the plurality of sets of historical return rate metrics, the resulting final return adjustment coefficients may be made more accurate.

A plurality of return adjustment coefficients at a plurality of time points from the delivery start point of the content delivery plan and the target time point may be applied to adjust the return rate metric in the embodiments discussed above. For the return rate metric to be considered, a return adjustment coefficient at a corresponding time point may be selected for adjustment.

In some embodiments, as more historical cost data and revenue data can be obtained, the return adjustment coefficient can be continuously determined, so that the return adjustment coefficient can reflect new characteristics of the content delivery plan or the content delivery party.

FIG. 6 shows a schematic structural block diagram of an apparatus 600 for return evaluation according to some embodiments of the present disclosure. The apparatus 600 may be implemented as or included in the content management system 120. The various modules/components in the apparatus 600 may be implemented by hardware, software, firmware, or any combination thereof.

As shown in the drawings, the apparatus 600 includes a metric obtaining module 610 configured to obtain at least one return rate metric of a content delivery plan at at least one time point, the return rate metric being determined based on a cost consumed at a corresponding time point and revenue returned at the corresponding time point. The apparatus 600 further includes an adjustment coefficient obtaining module 620 configured to obtain at least one return adjustment coefficient for the at least one time point of the content delivery plan. The apparatus 600 further includes a metric adjustment module 630 configured to adjust the at least one return rate metric respectively with the at least one return adjustment coefficient, to obtain at least one adjusted return rate metric. The apparatus 600 further includes a target metric determination module 640 configured to determine a target return rate metric for the content delivery plan based on the at least one adjusted return rate metric, the target return rate metric indicating a return rate metric that can be reached upon expiration of a revenue returning period after consuming a cost at the at least one time point.

In some embodiments, a return adjustment coefficient of the at least one return adjustment coefficient indicates a ratio of a return rate metric reached over a corresponding revenue returning time length starting from cost being consumed to a return rate metric reached upon expiration of the revenue returning period.

In some embodiments, the apparatus 600 further includes: a historical data obtaining module configured to obtain historical cost data and historical revenue data associated with the content delivery plan; and an adjustment coefficient determination module configured to determine, based on the historical cost data and the historical revenue data, a plurality of return adjustment coefficients respectively corresponding to a plurality of revenue returning time lengths within the revenue returning period.

In some embodiments, the adjustment coefficient determination module includes: a historical revenue determination module configured to determine, for a given historical cost consumed at a given historical time point in the historical cost data and from the historical revenue data, a plurality of pieces of historical revenue respectively obtained within the plurality of revenue returning time lengths starting from the given historical time point, the plurality of pieces of historical revenue being attributed to the given historical cost; a historical return rate metric determination module configured to determine a plurality of historical return rate metrics corresponding to the plurality of revenue returning time lengths, based on the plurality of pieces of historical revenue and the given historical cost; and a metric ratio-based adjustment coefficient determination module configured to determine, based on a ratio of a historical return rate metric corresponding to each revenue returning time length to a historical return rate metric upon expiration of the revenue returning period, a return adjustment coefficient corresponding to the revenue returning time length.

In some embodiments, the adjustment coefficient obtaining module includes: a return time determination module configured to determine, for a given time point among the at least one time point, a given revenue returning time length based on a time length between the given time point and a last time point among the at least one time point; and an adjustment coefficient selecting module configured to select, from the plurality of return adjustment coefficients, the at least one return adjustment coefficient corresponding to the given revenue returning time length.

In some embodiments, the plurality of historical return rate metrics comprise historical cost data and historical revenue data collected in a process of executing one or more additional content delivery plans, the one or more additional content delivery plans corresponding to a same content delivery party as the content delivery plan.

In some embodiments, the apparatus 600 further includes: a recommendation determination module configured to determine a budget usage recommendation for the content delivery plan based at least on the target return rate metric and an expected return rate metric for the content delivery plan.

In some embodiments, the recommendation determination module includes: an unadjusted metric determination module configured to determine an unadjusted return rate metric based on the at least one return rate metric; a metric selecting module configured to select a larger return rate metric from the target return rate metric and the unadjusted return rate metric; and a selected metric-based recommendation determination module configured to determine the budget usage recommendation based on the selected return rate metric and the expected return rate metric for the content delivery plan.

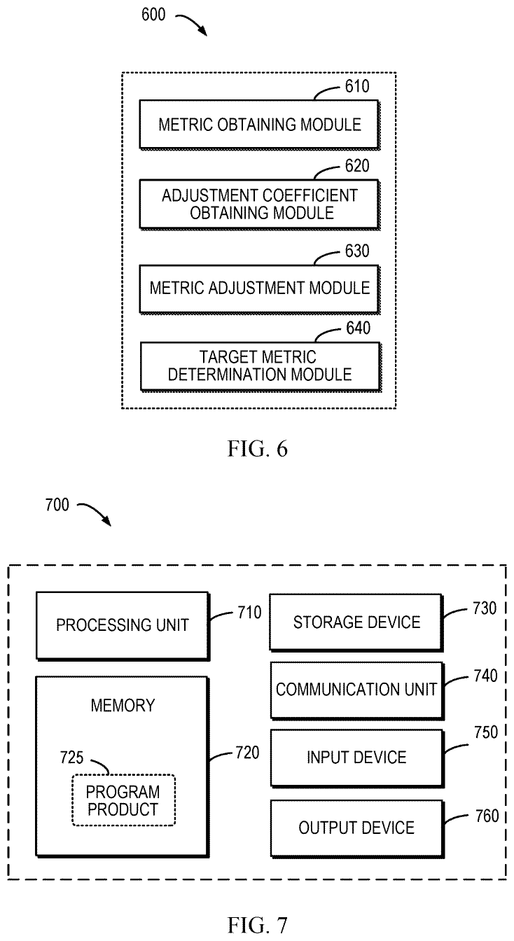

FIG. 7 illustrates a block diagram of an electronic device 700 in which one or more embodiments of the present disclosure may be implemented. It should be understood that the electronic device 700 shown in FIG. 7 is merely illustrative and should not constitute any limitation on the functionality and scope of the embodiments described herein. The electronic device 700 shown in FIG. 7 may be used to implement the content management system 120 of FIG. 1.

As shown in FIG. 7, the electronic device 700 is in the form of a general-purpose computing device. Components of the electronic device 700 may include, but are not limited to, one or more processors or processing units 710, a memory 720, a storage device 730, one or more communications units 740, one or more input devices 750, and one or more output devices 760. The processing unit 710 may be an actual or virtual processor and can perform various processes according to programs stored in the memory 720. In a multiprocessor system, a plurality of processing units executes computer executable instructions in parallel, so as to improve the parallel processing capability of the electronic device 700.

The electronic device 700 typically includes a number of computer storage media. Such media may be any available media that are accessible by electronic device 700, including, but not limited to, volatile and non-volatile media, removable and non-removable media. The memory 720 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium such as a flash drive, a magnetic disk, or any other medium that can be used to store information and/or data (e. g., training data for training) and that can be accessed within the electronic device 700.

The electronic device 700 may further include additional removable/non-removable, volatile/nonvolatile storage media. Although not shown in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. In addition, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or another network node.

The input device 750 may be one or more input devices such as a mouse, keyboard, trackball, etc. The output device 760 may be one or more output devices such as a display, speaker, printer, etc. The electronic device 700 may also communicate with one or more external devices (not shown) such as a storage device, a display device, or the like through the communication unit 740 as required, and communicate with one or more devices that enable a user to interact with the electronic device 700, or communicate with any device (e. g., a network card, a modem, or the like) that enables the electronic device 700 to communicate with one or more other electronic devices. Such communication may be performed via an input/output (I/O) interface (not shown).

According to an example implementation of the present disclosure, a computer readable storage medium is provided, on which a computer-executable instruction is stored, wherein the computer executable instruction is executed by a processor to implement the above-described method. According to an example implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is illustrative, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

1-18. (canceled)

19. A method for return evaluation, comprising:
obtaining at least one return rate metric of a content delivery plan at at least one time point, the return rate metric being determined based on a cost consumed at a corresponding time point and revenue returned at the corresponding time point;
obtaining at least one return adjustment coefficient for the at least one time point of the content delivery plan;
adjusting the at least one return rate metric respectively with the at least one return adjustment coefficient, to obtain at least one adjusted return rate metric; and
determining a target return rate metric for the content delivery plan based on the at least one adjusted return rate metric, the target return rate metric indicating a return rate metric that can be reached upon expiration of a revenue returning period after consuming a cost at the at least one time point.

20. The method of claim 19, wherein a return adjustment coefficient of the at least one return adjustment coefficient indicates a ratio of a return rate metric reached over a corresponding revenue returning time length starting from cost being consumed to a return rate metric reached upon expiration of the revenue returning period.

21. The method of claim 19, further comprising:
obtaining historical cost data and historical revenue data associated with the content delivery plan; and
determining, based on the historical cost data and the historical revenue data, a plurality of return adjustment coefficients respectively corresponding to a plurality of revenue returning time lengths within the revenue returning period.

22. The method of claim 21, wherein determining the plurality of return adjustment coefficients comprises:
for a given historical cost consumed at a given historical time point in the historical cost data, determining, from the historical revenue data, a plurality of pieces of historical revenue respectively obtained over the plurality of revenue returning time lengths starting from the given historical time point, the plurality of pieces of historical revenue being attributed to the given historical cost;
determining, based on the plurality of pieces of historical revenue and the given historical cost, a plurality of historical return rate metrics corresponding to the plurality of revenue returning time lengths; and
determining, based on a ratio of a historical return rate metric corresponding to each revenue returning time length to a historical return rate metric upon expiration of the revenue returning period, a return adjustment coefficient corresponding to the revenue returning time length.

23. The method of claim 21, wherein obtaining the at least one return adjustment coefficient comprises: for a given time point among the at least one time point, determining a given revenue returning time length based on a time length between the given time point and a last time point among the at least one time point; and selecting, from the plurality of return adjustment coefficients, the at least one return adjustment coefficient corresponding to the given revenue returning time length.

24. The method of claim 22, wherein the plurality of historical return rate metrics comprise historical cost data and historical revenue data collected in a process of executing one or more additional content delivery plans, and the one or more additional content delivery plans correspond to a same content delivery party as the content delivery plan.

25. The method of claim 19, further comprising:
determining a budget usage recommendation for the content delivery plan based at least on the target return rate metric and an expected return rate metric for the content delivery plan.

26. The method of claim 25, wherein determining the budget usage recommendation for the content delivery plan comprises:
determining an unadjusted return rate metric based on the at least one return rate metric;
selecting a larger return rate metric from the target return rate metric and the unadjusted return rate metric; and
determining the budget usage recommendation based on the selected return rate metric and the expected return rate metric for the content delivery plan.

27. An electronic device, comprising:
at least one processing unit; and
at least one memory coupled to the at least one processing unit and storing instructions for execution by the at least one processing unit, wherein the instructions, when executed by the at least one processing unit, cause the electronic device to perform at least:
obtaining at least one return rate metric of a content delivery plan at at least one time point, the return rate metric being determined based on a cost consumed at a corresponding time point and revenue returned at the corresponding time point;
obtaining at least one return adjustment coefficient for the at least one time point of the content delivery plan;
adjusting the at least one return rate metric respectively with the at least one return adjustment coefficient, to obtain at least one adjusted return rate metric; and
determining a target return rate metric for the content delivery plan based on the at least one adjusted return rate metric, the target return rate metric indicating a return rate metric that can be reached upon expiration of a revenue returning period after consuming a cost at the at least one time point.

28. The electronic device of claim 27, wherein a return adjustment coefficient of the at least one return adjustment coefficient indicates a ratio of a return rate metric reached over a corresponding revenue returning time length starting from cost being consumed to a return rate metric reached upon expiration of the revenue returning period.

29. The electronic device of claim 27, wherein the electronic device is further caused to perform:
obtaining historical cost data and historical revenue data associated with the content delivery plan; and
determining, based on the historical cost data and the historical revenue data, a plurality of return adjustment coefficients respectively corresponding to a plurality of revenue returning time lengths within the revenue returning period.

30. The electronic device of claim 29, wherein determining the plurality of return adjustment coefficients comprises:
for a given historical cost consumed at a given historical time point in the historical cost data, determining, from the historical revenue data, a plurality of pieces of historical revenue respectively obtained over the plurality of revenue returning time lengths starting from the given historical time point, the plurality of pieces of historical revenue being attributed to the given historical cost;
determining, based on the plurality of pieces of historical revenue and the given historical cost, a plurality of historical return rate metrics corresponding to the plurality of revenue returning time lengths; and
determining, based on a ratio of a historical return rate metric corresponding to each revenue returning time length to a historical return rate metric upon expiration of the revenue returning period, a return adjustment coefficient corresponding to the revenue returning time length.

31. The electronic device of claim 29, wherein obtaining the at least one return adjustment coefficient comprises: for a given time point among the at least one time point, determining a given revenue returning time length based on a time length between the given time point and a last time point among the at least one time point; and selecting, from the plurality of return adjustment coefficients, the at least one return adjustment coefficient corresponding to the given revenue returning time length.

32. The electronic device of claim 30, wherein the plurality of historical return rate metrics comprise historical cost data and historical revenue data collected in a process of executing one or more additional content delivery plans, and the one or more additional content delivery plans correspond to a same content delivery party as the content delivery plan.

33. The electronic device of claim 27, wherein the electronic device is further caused to perform:
determining a budget usage recommendation for the content delivery plan based at least on the target return rate metric and an expected return rate metric for the content delivery plan.

34. The electronic device of claim 33, wherein determining the budget usage recommendation for the content delivery plan comprises:
determining an unadjusted return rate metric based on the at least one return rate metric;
selecting a larger return rate metric from the target return rate metric and the unadjusted return rate metric; and
determining the budget usage recommendation based on the selected return rate metric and the expected return rate metric for the content delivery plan.

35. A non-transitory computer-readable storage medium having a computer program stored thereon, the computer program, when executed by a processor, implements a method comprising:
obtaining at least one return rate metric of a content delivery plan at at least one time point, the return rate metric being determined based on a cost consumed at a corresponding time point and revenue returned at the corresponding time point;
obtaining at least one return adjustment coefficient for the at least one time point of the content delivery plan;
adjusting the at least one return rate metric respectively with the at least one return adjustment coefficient, to obtain at least one adjusted return rate metric; and
determining a target return rate metric for the content delivery plan based on the at least one adjusted return rate metric, the target return rate metric indicating a return rate metric that can be reached upon expiration of a revenue returning period after consuming a cost at the at least one time point.

36. The non-transitory computer-readable storage medium of claim 35, wherein a return adjustment coefficient of the at least one return adjustment coefficient indicates a ratio of a return rate metric reached over a corresponding revenue returning time length starting from cost being consumed to a return rate metric reached upon expiration of the revenue returning period.

37. The non-transitory computer-readable storage medium of claim 35, wherein the method further comprises:
obtaining historical cost data and historical revenue data associated with the content delivery plan; and
determining, based on the historical cost data and the historical revenue data, a plurality of return adjustment coefficients respectively corresponding to a plurality of revenue returning time lengths within the revenue returning period.

38. The non-transitory computer-readable storage medium of claim 37, wherein determining the plurality of return adjustment coefficients comprises:
for a given historical cost consumed at a given historical time point in the historical cost data, determining, from the historical revenue data, a plurality of pieces of historical revenue respectively obtained over the plurality of revenue returning time lengths starting from the given historical time point, the plurality of pieces of historical revenue being attributed to the given historical cost;
determining, based on the plurality of pieces of historical revenue and the given historical cost, a plurality of historical return rate metrics corresponding to the plurality of revenue returning time lengths; and
determining, based on a ratio of a historical return rate metric corresponding to each revenue returning time length to a historical return rate metric upon expiration of the revenue returning period, a return adjustment coefficient corresponding to the revenue returning time length.
